(19) United States
(12) Patent Application Publication
(10) Pub. No.: US 2026/0077723 A1
(43) Pub. Date: Mar. 19, 2026

(54) Tray and Stowing Compartment

(71) Applicant: Bayerische Motoren Werke Aktiengesellschaft, Muenchen (DE)

(72) Inventors: Florian BOEHEIM, Muenchen (DE); Christian ISING, Muenchen (DE)

(21) Appl. No.: 19/105,847

(22) PCT Filed: Nov. 13, 2023
(86) PCT No.: PCT/EP2023/081551

§ 371 Date: Feb. 24, 2025

(30) Foreign Application Priority Data
Dec. 6, 2022 (DE) 10 2022 132 293.9

(51) Int. Cl. B60R 11/02; B60R 11/00

(52) U.S. Cl. CPC B60R 11/0241; B60R 2011/0075

(57) ABSTRACT

A tray, in particular for a mobile terminal, has a base element and a support element which is movably arranged at a distance thereto, wherein the support element forms or provides an arranging surface, and the support element and the base element are connected via a wall element which is flexible at least in some regions such that a closed volume is formed between the support element and the base element, the volume being designed to function as a pneumatic spring.

### BACKGROUND AND SUMMARY

The present invention relates to a tray, in particular for a mobile terminal, such as a smartphone or the like, and to a stowage compartment, as used in motor vehicles.

Trays of the type in question are in particular provided for stowing or storing mobile terminals, such as smartphones, in motor vehicles. Some challenges arise here, since the heat development of the devices, be it during charging or alternatively during operation, must not be underestimated.

DE 10 2018 216 281 A1 for example discloses an assembly for a vehicle, in particular a motorcycle, comprising a vehicle component, a stowage compartment fastened to the vehicle component, and a negative-pressure source, wherein the stowage compartment has a receiving space for a mobile terminal, an air feed into the receiving space and an air discharge from the receiving space, the air discharge being fluidically connected to the negative-pressure source. In this way, an exchange of air or cooling can be realized. Specifically in the case of powered cycles, such as motorcycles, there is an additional challenge in providing some sort of vibration decoupling by way of the tray, since during operation significant vibrations occur which should as far as possible not be transmitted to the tray.

It is therefore an object of the present invention to provide a tray, for example for a mobile terminal, and a stowage compartment, the intention being to enable the best possible vibration decoupling, preferably while having a simultaneous optimal cooling function.

This object is achieved by a tray and by a stowage compartment according to the independent claim(s). Further advantages and features will become apparent from the dependent claims and from the description and the appended figures.

According to the invention, a tray, in particular for a mobile terminal, such as a smartphone, comprises a base element and a support element which is spaced apart therefrom and movable relative thereto, wherein the support element forms or provides or has an arrangement surface, and wherein the support element and the base element are connected by way of an at least regionally flexible wall element in such a way that a closed volume designed to act as an air spring or as an air cushion is formed between the support element and the base element. This advantageously makes it possible to obtain optimal vibration decoupling. Depending on the air pressure set in the volume, the stiffness of the air spring can be set.

According to one embodiment, the tray comprises a cover element, wherein the cover element, which is for example movable, in particular pivotable, is designed to cover or shield the arrangement surface. The cover element is preferably designed to form together with the support element an arrangement space into which an article to be transported, such as a smartphone, can be inserted. According to one embodiment, the support element comprises at least one fastening means which can be used to captively fasten the device to be transported, such as the smartphone, to the support element. Such a fastening means may, for example, be a hook-and-loop fastener.

According to one embodiment, the base element, preferably also the support element, is formed as a plate or plate-like element, on which the flexible wall element is arranged at the periphery. The flexible wall element can as such be formed from a flexible, movable or soft, in particular elastically deformable, material. As an alternative, even only certain regions or portions are soft, flexible, elastically deformable, etc. The flexibility of the wall element should in particular be designed such that the support element is movable relative to the base element. In particular, the at least regionally flexible wall element thus enables movable mounting of the support element relative to the base element.

According to one embodiment, the aforementioned plate-like base element is connected at the periphery to the plate-like support element by way of the flexible wall element, such that an air spring or an air cushion is formed. As an alternative, multiple air springs/air cushions may also be formed between the base element and the support element.

According to one embodiment, the volume has at least one opening to exchange air with the surroundings. Expediently, air can be drawn in or escape via the opening. Such an opening expediently also acts as a throttle, as a result of which a certain damping effect during springing can be achieved.

According to a preferred embodiment, the volume is able to be flowed through. This expediently makes it possible to discharge heat, that is to say in particular heat introduced into the volume for example by way of a mobile terminal, such as a smartphone. The flow-through action makes it possible for the heat to be discharged toward the outside, such that, consequently, optimal cooling of the device lying on the tray is achieved while simultaneously having optimal vibration decoupling. At the same time, it is advantageously possible to provide a spring effect, in particular a spring/damper effect.

According to one embodiment, a multiplicity of first openings or at least one first opening is formed in the base element, wherein a multiplicity of second openings or at least one second opening is formed in the support element. In addition or as an alternative, at least one third opening is formed in the wall element. Here, if there are multiple of them, the openings are in each case expediently distributed uniformly or non-uniformly in the respective element. According to one embodiment, only certain regions or portions of the respective element are provided with openings. However, as an alternative, the base element and/or the support element and/or the wall element may be provided completely or over their full area with such openings. Typically, such openings are small or relatively small and for example have a diameter of between 0.3 and 1.3 mm, wherein diameters of different size can also be combined with one another.

According to one embodiment, the first openings or at least one first opening are/is formed as air inlet openings/opening, wherein the second openings or at least one second opening are/is formed as air outlet openings/opening. According to a preferred embodiment, no openings are formed in the wall element. In this embodiment, the tray is expediently flowed through or able to be flowed through from bottom to top, that is to say from the base element toward the support element. This advantageously makes it possible to combine ventilation with decoupling or vibration decoupling of the support element. A multiplicity of air inlet openings is preferably provided in the base plate. If these are flowed through, the support element is raised or lifted off, since an air cushion forms in the volume. This advantageously acts as the already mentioned air spring. At the same time, air, in particular heated air, can escape via the air outlet openings, expediently in the support element.

Preferably, openings, cf. the aforementioned second openings, are formed in the support element (also) in the region of the arrangement surface, that is to say in the region in which the device to be transported is arranged. These are not used to let out air since they are concealed by the device/smartphone. They advantageously enable good conduction of heat from the device/smartphone into the volume. From there, the heated air can then escape via the at least one air outlet opening.

The at least one air inlet opening is expediently connected in a suitable manner to a channel or the like via which an air flow can be conducted to the at least one air inlet opening. Preferably, the channel is formed in such a way that all the air inlet openings can be reached simultaneously. It is thus expediently not necessary for each air inlet opening to be connected to a separate (air) channel, but this would also be possible.

According to one embodiment, air-guiding elements, such as chambers, winglets or the like, are provided within the volume, in order to enable optimal air distribution, air circulation (within the volume) and also air discharge toward the air outlet opening(s).

According to one embodiment, in addition or as an alternative, at least one air inlet opening or at least one air outlet opening is also provided in the flexible wall element.

As already mentioned, the flexible wall element is expediently at least regionally formed from a textile or rubber material. The flexibility can thus be set by way of the material itself, but additionally or alternatively also by way of the geometric design. According to one embodiment, the wall element is formed in the manner of a bellows.

According to one embodiment, the tray comprises means for generating an air flow, as a result of which the volume is able to be flowed through or can be flowed through actively. Such means may, for example, be a blower or the like, which is connected in air-conducting fashion to at least one air inlet opening. As an alternative, means which are already present in the motor vehicle may also be used. This may for example mean the inlet region of an internal combustion engine, in which, at least temporarily, both positive and negative pressure can be applied. The aforementioned flow-through action can also be brought about by virtue of operation being performed, at least additionally, with negative pressure.

According to one embodiment, the tray comprises an air guide designed to in particular enable the volume to be flowed through passively. In the case of the passive flow-through action, for example the relative wind of the vehicle is utilized in order to enable the volume to be flowed through.

According to one embodiment, the tray comprises a charging device, in particular an inductive charging device. According to one embodiment, the support element is equipped with a charging device, in particular an inductive charging device.

The invention also relates to a stowage compartment, in particular for a motor vehicle, in particular a powered cycle, such as a scooter, a motorcycle or generally a tilting vehicle, wherein leaning multi-wheel (LNM) vehicles are also intended to be included. Such a stowage compartment may also be referred to as glove compartment. The stowage compartment may be open or closed. According to a preferred embodiment, it enables an exchange of air with the surroundings. The stowage compartment in particular comprises a space or region in which the tray is arranged. The space or region is preferably able to be flowed through.

Further advantages and features will become apparent from the description below of one embodiment of the tray with reference to the appended figures.

### BRIEF DESCRIPTION OF THE DRAWINGS

FIG. 1 is a schematic view of one embodiment of a tray in a first state; and

FIG. 2 shows the embodiment of the tray known from FIG. 1 in a second state.

### DETAILED DESCRIPTION OF THE DRAWINGS

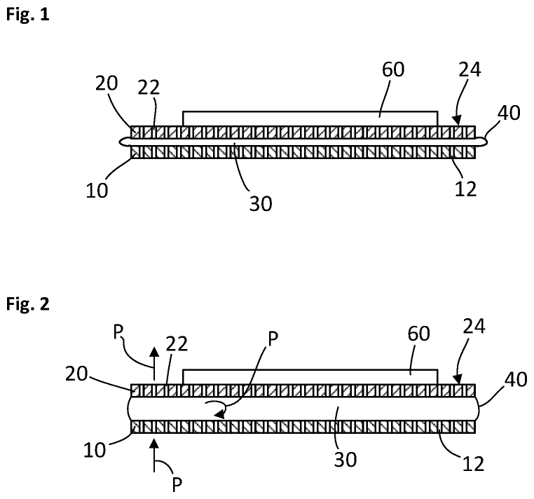

FIG. 1 shows a schematic view of one embodiment of a tray, comprising a base element 10 and a support element 20 arranged thereabove. The support element 20 and the base element 10 are connected by way of an at least regionally flexible wall element 40. The present case concerns a sectional illustration, such that a respective multiplicity of openings 12 and 22 can be seen both in the support element 20 and in the base element 10. The support element 20 comprises an arrangement surface 24 on which, in the present case, a mobile terminal 60, for example a smartphone, is arranged or rests. In the present case, the first openings 12 formed in the base element 10 serve as air inlet openings, wherein the second openings 22 formed in the support element 20 serve as air outlet openings. However, in the present case, the volume 30 formed inside is not flowed through, which is also apparent in relation to the bulging wall element 40.

FIG. 2 shows the tray known from FIG. 1, with the volume 30 now being flowed through. This is depicted by way of the arrows, which are denoted by the reference sign P. The present case depicts that air is let in only via one air inlet opening 12. Similarly, air is let out via only one second opening 22. In reality, preferably all the first openings 12 are used to let in air, while preferably all the second openings 22 are used to let out air. This does not apply to the openings 22 which are concealed by the device 60. These can expediently be used to realize good discharge of heat into the volume 30. The air accumulates in the volume 30, as a result of which the air spring can be built up, since the second openings 22 also provide a throttle effect. Air-guiding elements or the like (not illustrated here) may also be provided inside the volume 30. In the present case, a tray with optimal vibration decoupling and a simultaneously very good cooling function is provided.

### LIST OF REFERENCE SIGNS

10 Base element
12 (First) opening
20 Support element
22 (Second) opening
24 Arrangement surface
30 Volume
40 Wall element
60 Mobile terminal
P Air flow

1.-10. (canceled)

11. A tray, comprising:
a base element,
a support element which is spaced apart from the base element and movable relative thereto,
wherein the support element forms or provides an arrangement surface; and
an at least regionally flexible wall element, by which the support element and the base element are connected,
wherein a closed volume configured to act as an air spring is formed between the support element and the base element by the flexible wall element.

12. The tray according to claim 11, wherein
the volume has at least one opening to exchange air with surroundings.

13. The tray according to claim 11, wherein the volume is able to be flowed through.

14. The tray according to claim 11, wherein
a multiplicity of first openings is formed in the base element, and
a multiplicity of second openings is formed in the support element.

15. The tray according to claim 14, wherein
the first openings are formed as air inlet openings, and
the second openings are formed as air outlet openings.

16. The tray according to claim 11, wherein
the flexible wall element is at least regionally formed from a textile and/or rubber material.

17. The tray according to claim 11, further comprising:
means for generating an air flow, as a result of which the volume is able to be flowed through actively.

18. The tray according to claim 11, wherein
the tray comprises an air guide to enable the volume to be flowed through passively.

19. The tray according to claim 11, further comprising:
a charger in the tray.

20. The tray according to claim 19, wherein the charger is an inductive charger.

21. The tray according to claim 11, wherein the tray is configured to support a mobile terminal.

22. A stowage compartment for a motor vehicle comprising at least one tray according to claim 11.
